(19) United States
(12) Patent Application Publication
(10) Pub. No.: US 2020/0206750 A1
(43) Pub. Date: Jul. 2, 2020

(54) APPARATUS AND METHOD OF FEEDING A FEED SLURRY INTO A SEPARATING DEVICE

(71) Applicant: TUNRA Ltd., Callaghan, New South Wales (AU)

(72) Inventors: Kevin Patrick Galvin, Callaghan (AU); James Edward Dickinson, Callaghan (AU); Taavi Orupold, Pinkenba (AU); Michael James Gardiner, Pinkenba (AU)

(21) Appl. No.: 16/631,787

(22) PCT Filed: Jul. 13, 2018
(86) PCT No.: PCT/AU2018/050725

§ 371 Date: Jan. 16, 2020

(30) Foreign Application Priority Data
Jul. 17, 2017 (AU) 2017902767

(51) Int. Cl. B03D 1/24

(52) U.S. Cl. CPC B03D 1/245; B03D 2203/08

(57) ABSTRACT

The present invention provides an apparatus and method for feeding a feed slurry into a device for separating low density particles from the feed slurry. The apparatus comprises a conduit having a slurry inlet, a gas feed inlet, a plurality of hollow tubes and an outlet. The hollow tubes are configured to combine the feed slurry from the slurry inlet and gas from the gas feed inlet. The hollow tubes comprise a porous section to generate bubbles of substantially uniform size into the slurry for adhering to the low density particles. Slurry flows in axially aligned hollow tubes as gas is introduced through the porous sections into the slurry. Alternatively, slurry flows around hollow tubes arranged perpendicular to the conduit longitudinal axis as gas is discharged through the porous sections into the slurry.

### FIELD OF THE INVENTION

This invention relates to a method and apparatus for feeding a feed slurry into a separating device, as well as a method and apparatus for separating low density particles from a feed slurry. The invention has been devised particularly though not solely as an enhanced process of froth flotation as applied to fine coal or fine minerals used to concentrate hydrophobic particles.

Throughout this specification the term “low density particles” is used to refer to particles that may be solid-like, liquid-like, or gas-like, and in all cases less dense than the surrounding fluid which may for example be water. More specific examples of low density particles may include oil drops or even gas bubbles. Throughout this specification the term “gas” is used to refer to a solution that may be gas-like, liquid-like, or solid like. More specific examples of a solution may include water, air, or even emulsions.

### BACKGROUND TO THE INVENTION

The following discussion of the prior art is intended to present the invention in an appropriate technical context and allow its advantages to be properly appreciated. Unless clearly indicated to the contrary, however, reference to any prior art in this specification should not be construed as an express or implied admission that such art is widely known or forms part of common general knowledge in the field.

It has been proposed in the past to separate low density particles from a feed slurry by introducing the feed slurry above a set of parallel inclined channels where the vast majority of the slurry is transported downwardly through the inclined channels. The low density particles then escape the flow, rising towards the downward facing inclined surfaces of the channels, collecting as an inverted sediment and then sliding up the inclined channels. By this means, the low density particles concentrate on the top half of the device and in turn report to the overflow, typically by way of an overflow launder. Wash water may be added at the top and allowed to flow downwards in order to remove possible contaminants. The inclined channels are typically formed by an arrangement of inclined parallel plates. This inclined plate classifier is often been referred to as a “reflux classifier”. The method and apparatus relating to the reflux classifier is described in International Patent Application Number PCT/AU2007/001817, whose specification is hereby incorporated by reference in its entirety, and with specific reference to FIG. 5 of that specification.

In one configuration, the low density particles escape the downward flow of the slurry with the assistance of by an upward fluidisation flow from below the channels. This configuration is described in International Patent Application Number PCT/AU2007/001817. In another configuration, the low density particles escape the downward flow of the slurry, against a downward fluidisation flow from above the channels. In this configuration, the reflux classifier is fully inverted and in one embodiment provides an upper fluidisation chamber at the top end of the device. Hence, this alternative configuration is called an “inverted reflux classifier” is described in International Patent Application Number PCT/AU2011/000682, whose specification is hereby incorporated by reference in its entirety.

### SUMMARY OF THE INVENTION

The present invention has been developed to further improve or provide an alternative to the apparatus and methods of feeding a reflux classifier or an inverted reflux classifier and their respective modes of operation.

Accordingly, in a first aspect, the present invention provides an apparatus for feeding a feed slurry into a device for separating low density particles from the feed slurry, the apparatus comprising:

a conduit having a slurry inlet for receiving the feed slurry, a gas feed inlet for receiving a gas and an outlet for discharging the gas and feed slurry; and

a plurality of hollow tubes within the conduit for combining the feed slurry and gas from the first and gas feed inlets;

wherein one or more of the hollow tubes comprise a porous section to generate bubbles of substantially uniform size into the feed slurry flowing within the conduit.

Preferably, the porous section comprises a porous surface.

Preferably, the porous section or surface is formed at a lower portion of the one or more hollow tubes. In alternative configurations, the porous section or surface is formed at a middle portion or at an upper portion of the one or more hollow tubes, or the porous section or surface forms the entirety of the one or more hollow tubes. In a further alternative, the porous section or surface is formed at one or more portions of the one or more hollow tubes. In one embodiment, the gas is conveyed from the gas feed inlet into the hollow tubes through the porous surface.

Preferably, the one or more hollow tubes comprise a sparger section forming the porous section or surface. In some embodiments, the one or more hollow tubes comprise an open section covered by porous material or a membrane.

Preferably, the porous section is formed in the sidewall of the one or more hollow tubes. It is also preferred that the porous section is in fluid communication with the gas feed inlet to receive gas from the gas feed inlet into the one or more hollow tubes.

Preferably, the porous section comprises pores or perforations having an average diameter of less than 1 mm. More preferably, the average pore diameter is less than 0.1 mm. In some embodiments, the average pore diameter may be 0.1 microns, 0.2 microns, 2 microns, 10 microns or 100 microns. In other embodiments, the average pore diameter may be within a range across the above sizes.

Preferably, the porous section has a porosity of between 1% to 90%, preferably between 10% and 80%. It will be understood by those skilled in the art that the term “porosity” refers to the fraction of the wall containing connected holes within the porous section. It will also be understood that the permeability is associated with the pressure drop need to produce a given flow, which in turn is influenced by the pore size, the tortuosity of the pores through the material (path length) and the porosity.

Preferably, the one or more hollow tubes are positioned axially within the conduit. Alternatively, the one or more hollow tubes are positioned substantially perpendicular to a longitudinal axis of the conduit.

Preferably, the one or more hollow tubes have one or more first openings for receiving the feed slurry from the slurry inlet. More preferably, the first openings each comprise a first open end of the hollow tubes.

Preferably, the one or more hollow tubes have one or more second openings for receiving gas from the gas feed inlet. In some embodiments, the second openings are formed in a sidewall of the one or more hollow tubes. Most preferably, the second openings comprise the porous section. Thus, the porous section of each of the one or more hollow tubes is in fluid communication with the gas feed inlet to receive gas from the gas feed inlet and generate the bubbles of substantially uniform size into the slurry flowing in the one or more hollow tubes. In other embodiments, the second openings each comprise an open end of the hollow tubes. In this case, the one or more hollow tubes each have an open end in fluid communication with the gas feed inlet.

Preferably, one or more hollow tubes have one or more third openings for discharging the feed slurry and gas into the conduit. More preferably, the third openings each comprise a second open end of the hollow tubes. In one embodiment, the second open end is opposite to the first open end.

In some embodiments, one or more hollow tubes have one or more fourth openings to discharge the gas into the feed slurry within the conduit. Preferably, the fourth openings are formed in a sidewall of the one or more hollow tubes. Most preferably, the second openings comprise the porous section. Thus, the porous section of each of the one or more hollow tubes discharges the gas from the one or more hollow tubes in the form of the bubbles of substantially uniform size into the feed slurry flowing within the conduit.

Preferably, the one or more hollow tubes each comprise an inner conduit, tube or pipe. More preferably, there is a plurality of inner conduits, tubes or pipes. It is further preferred that one or more inner conduits, tubes or pipes also have a porous section for generating the bubbles of substantially uniform size into the feed slurry. Hence, the bubbles of substantially uniform size are able to adhere to the low density particles in the slurry. In some embodiments, the porous section is formed in a sidewall of the one or more inner conduits, tubes or pipes. In other embodiments, the inner conduits, tubes or pipes comprise an open end for receiving the gas from the gas feed inlet. In further embodiments, the porous sections of the inner conduits, tubes or pipes comprise sparger-like structures.

Preferably, the one or more hollow tubes are symmetrical. In some embodiments, the one or more hollow tubes comprise an expanded portion having a cross-sectional area greater than the cross-sectional area of the remainder of the one or more hollow tubes. In one preferred embodiment, the expanded portion comprises an enlarged open end of the one or more hollow tubes. In a further alternative, the one or more hollow tubes comprise a contracted portion having a cross-sectional area less than the cross-sectional area of the remainder of the one or more hollow tubes. In one preferred embodiment, the contracted portion comprises a contracted open end of the one or more hollow tubes.

Preferably, the conduit may have a first portion with a cross-sectional area greater than the cross-sectional area of a second portion of the conduit. Alternatively, the conduit may have a first portion with a cross-sectional area less than the cross-sectional area of a second portion of the conduit.

In a second aspect, the present invention provides an apparatus for separating low density particles from a feed slurry, comprising:

a chamber having a plurality of inclined channels;

a slurry feeder arranged to feed the feed slurry into the feed apparatus of the first aspect of the invention; and

a gas feeder arranged to feed gas into the feed apparatus;

wherein the outlet of the feed apparatus is arranged to feed the gas and slurry into the chamber.

Preferably, the plurality of inclined channels is located toward or at a lower end of the chamber. In alternative configurations, the plurality of inclined channels is located in other locations of the chamber, including an upper end or middle portion.

Preferably, the plurality of inclined channels is formed by a set of inclined surfaces. More preferably, the set of inclined surfaces comprise an array of parallel inclined plates.

Preferably, the gas and slurry form a downward fluidisation flow toward the inclined channels. More preferably, an upper end of the chamber is substantially enclosed to facilitate formation of the downward fluidisation flow.

Preferably, the gas and slurry form an inverted fluidised bed in the chamber above the inclined channels.

Preferably, the gas and slurry discharge from the feed apparatus outlet into the chamber above the inclined channels. More preferably, the gas and slurry discharge from the feed apparatus into an upper end of the chamber. In other embodiments, the gas and slurry may discharge into other parts of the chamber, including a middle portion or even a lower end of the chamber.

Preferably, the apparatus comprises at least one outlet for removing the low density particles from the chamber. In one embodiment, the at least one outlet comprises an upper control device arranged to allow concentrated suspensions of low density particles to be removed from an upper end of the chamber at a controlled rate.

Preferably, the substantially enclosed upper end of the chamber is shaped to direct concentrated suspensions of low density particles toward the at least one outlet. More preferably, the upper end of the chamber is shaped as a cone with the at least one outlet comprising a valve located at the apex of the cone.

Preferably, the upper end of the chamber is perforated, and a wash water feeder is arranged to introduce wash water under pressure into the chamber through the perforations.

Preferably, the apparatus comprises at least one outlet for removing the denser particles from the chamber. In one embodiment, the at least one outlet comprises a lower control device arranged to allow denser particles to be removed from a lower end of the chamber below the inclined channels at a controlled rate. More preferably, the lower control device comprises a valve or a pump.

Preferably the upper and lower control devices are each operable by measuring the depth of low density particles in the upper end of the chamber and opening or closing the valves and/or operating the pump to keep the depth of low density particles within a predetermined range.

A third aspect of the present invention provides a method of feeding gas and a feed slurry into a device for separating low density particles from the feed slurry, comprising:

introducing the feed slurry into a slurry inlet of a conduit;

introducing gas into a gas feed inlet of the conduit;

mixing the feed slurry and gas using a plurality of hollow tubes so that the feed slurry and gas are discharged from an outlet of the conduit into the separating device; and

providing one of more of the hollow tubes with a porous section to generate bubbles of substantially uniform size into the feed slurry flowing within the conduit.

Preferably, the method further comprises providing the porous section with a porous surface. More preferably, the method comprises forming the porous surface at a lower portion of the one or more hollow tubes. In other embodiments, the porous surface may be formed at a middle or upper portion of the one or more hollow tubes. In one embodiment, the method further comprises introducing the gas from the gas feed inlet into the plurality of hollow tubes through the porous surface.

Preferably, the method further comprises axially positioning the one or more hollow tubes within the conduit. Alternatively, the method further comprises positioning the one or more hollow tubes substantially perpendicular to a longitudinal axis of the conduit.

Preferably, the method further comprises introducing the feed slurry from the slurry inlet into the plurality of hollow tubes through one or more first openings. More preferably, the method further comprises introducing the feed slurry from the slurry inlet into the plurality of hollow tubes through a first open end of the one or more hollow tubes. In one embodiment, the method comprises introducing the gas from the gas feed inlet into the one of more hollow tubes through the porous section or surface to generate the bubbles of substantially uniform size into the slurry flowing along the one of more hollow tubes.

Preferably, the method further comprises introducing the gas from the gas feed inlet into the plurality of hollow tubes through one or more second openings of the one or more hollow tubes. More preferably, the method further comprises introducing the gas from the gas feed inlet into the plurality of hollow tubes through a sidewall of the one or more hollow tubes. In other embodiments, the method further comprises introducing the gas from the gas feed inlet into the plurality of hollow tubes through one or more open ends of the one or more hollow tubes. In some embodiments, the method comprises introducing the gas from the gas feed inlet into the one or more hollow tubes and discharging the gas through the porous section or surface in the form of the bubbles of substantially uniform size into the feed slurry flowing within the conduit.

Preferably, the method further comprises discharging the feed slurry and gas from one or more third openings of the one or more hollow tubes. More preferably, the method further comprises discharging the feed slurry and gas from a second open end of the one or more hollow tubes.

Preferably, the method further comprises introducing the gas from the gas feed inlet into the conduit using the plurality of hollow tubes. In some embodiments, the method further comprises discharging the gas into the feed slurry through a sidewall of the one or more hollow tubes.

A fourth aspect of the present invention provides a method of separating low density particles from a feed slurry, comprising:

introducing the feed slurry and a gas into a device for separating the low density particles from the feed slurry according to the method of the third aspect of the invention, wherein the separating device comprises a chamber having plurality of inclined channels;

allowing the slurry to flow downwardly through the inclined channels such that the low density particles escape the flow by sliding up the inclined channels while the denser particles in the slurry slide down the channels; and

removing the low density particles from the chamber.

Preferably, the method further comprises allowing the low density particles to move upwardly at a controlled rate through one or more confined passages between the outer walls of the feed apparatus and the walls of the chamber to an overflow launder.

Preferably, the method further comprises removing the denser particles from the lower end of the chamber.

Preferably, the method further comprises forming an inverted fluidised bed in the chamber above the plurality of inclined channels.

Preferably, the above methods also comprise substantially enclosing an upper end of the chamber to facilitate formation of a downward fluidisation flow.

Preferably, the method further comprises locating the plurality of inclined channels toward or at a lower end of the chamber. In some embodiments, the method further comprises locating the plurality of inclined channels toward or at a middle portion or upper end of the chamber.

It is further preferred that the above methods also comprise providing a plurality of inclined surfaces to form the plurality of inclined channels. More preferably, the plurality of inclined surfaces is formed by an array of parallel inclined plates.

Preferably, the method further comprises allowing the low density particles to form into a concentrated suspension at the upper end of the chamber.

Preferably, the method further comprises removing the low density particles at a controlled rate from an upper end of the chamber.

Preferably, the method further comprises introducing wash water under pressure into the upper end of the chamber. More preferably, the method further comprises introducing the wash water uniformly through the enclosed upper end of the chamber.

In some embodiments, the low density particles are guided to an exit point in the upper end of the chamber where it is removed at the controlled rate by the operation of an upper control device, preferably a valve.

In some embodiments, the denser particles are removed from a lower end of the chamber at a controlled rate by the operation of a lower control device, preferably a valve or pump.

Preferably, the operation of the upper and lower control devices is controlled by measuring the suspension density in the upper part of the chamber and operating the upper and lower control devices to keep the depth of low density particles within a predetermined range in the upper end of the chamber. Alternatively, the operation of the upper and lower control devices is controlled by measuring the suspension density in the lower part of the chamber.

Unless the context clearly requires otherwise, throughout the description and the claims, the words “comprise”, “comprising”, and the like are to be construed in an inclusive sense as opposed to an exclusive or exhaustive sense; that is to say, in the sense of “including, but not limited to”.

Furthermore, as used herein and unless otherwise specified, the use of the ordinal adjectives “first”, “second”, “third”, etc., to describe a common object, merely indicate that different instances of like objects are being referred to, and are not intended to imply that the objects so described must be in a given sequence, either temporally, spatially, in ranking, or in any other manner.

### BRIEF DESCRIPTION OF THE DRAWINGS

Preferred embodiments of the invention will now be described, by way of example only, with reference to the accompanying drawings in which:

FIG. 1 is a perspective view of an apparatus according to one embodiment of the invention;

FIG. 2 is a partial cut-away view of the apparatus of FIG. 1;

FIG. 3 is a bottom view of the apparatus of FIG. 1; and

FIG. 4 is a partial cut-away view of the apparatus of FIG. 1 mounted or fitted to a separation device.

FIG. 5 are top views of other embodiments of the invention;

FIG. 6 are end views of other embodiments of the hollow tubes employed in embodiments of the invention;

FIG. 7 is a top view of a further embodiment of the invention;

FIG. 8 is a side view of the embodiment of FIG. 7;

FIG. 9 is a top view of yet another embodiment of the invention; and

FIG. 10 is a side view of the embodiment of FIG. 9.

### DETAILED DESCRIPTION OF EMBODIMENTS OF THE INVENTION

The present invention will now be described with reference to the following examples which should be considered in all respects as illustrative and non-restrictive. In the Figures, corresponding features within the same embodiment or common to different embodiments have been given the same reference numerals.

The preferred forms of the invention as described below relate to the method and apparatus being used for froth flotation, as typically applied to fine particles of coal and mineral matter and used to concentrate hydrophobic particles of coal or minerals.

These hydrophobic particles selectively adhere to the surface of air bubbles, leaving hydrophilic particles in suspension between the bubbles. Thus, once the hydrophobic particles become attached to the air bubbles a new hybrid particle is formed which is of an overall density much less than the density of the water. The attached hydrophobic particle then has a segregation velocity in the upwards direction which is very high compared to the downward superficial velocity of the suspension of denser particles.

In most flotation situations certain reagents need to be added to promote flotation. A collector may be added to promote the hydrophobicity of the hydrophobic coal particles. In particular, a surfactant (sometimes called a “frother”) is added to stabilise the bubbles and hence the foam formed as the bubbles seek to exit the bulk liquid. Surfactant adsorbs at the surface of the bubble helping to prevent bubble coalescence, and hence preserving the “low density particles”. This is especially important when the bubbles are forced through the top valve.

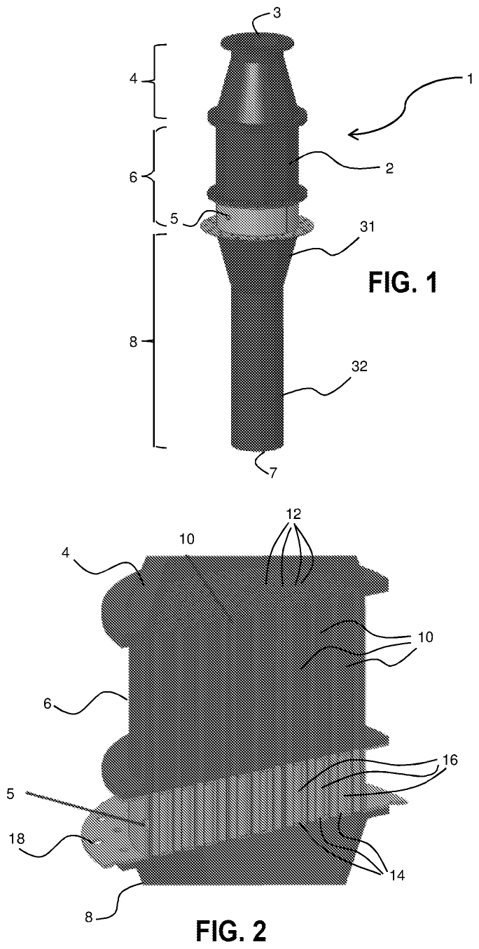

In the described embodiment shown in FIGS. 1 to 4, a more efficient and convenient arrangement is provided to feed the feed slurry and gas into a separating device for separating low density particles from a feed slurry containing the low density particles and denser particles and/or matter. In particular, the described embodiment has been developed to feed the feed slurry and gas into a reflux classifier or inverted reflux classifier, as described in International Patent Application Numbers PCT/AU2007/001817 and PCT/AU2011/000682, respectively.

Referring FIG. 1, the feed apparatus 1 according to the embodiment of the invention comprising a conduit or chamber 2 having a slurry inlet 3 located in an upper portion 4 of the apparatus 1, a gas feed inlet 5 located in a middle portion 6 of the apparatus and a discharge outlet 7 located at one end of a lower portion 8 of the apparatus.

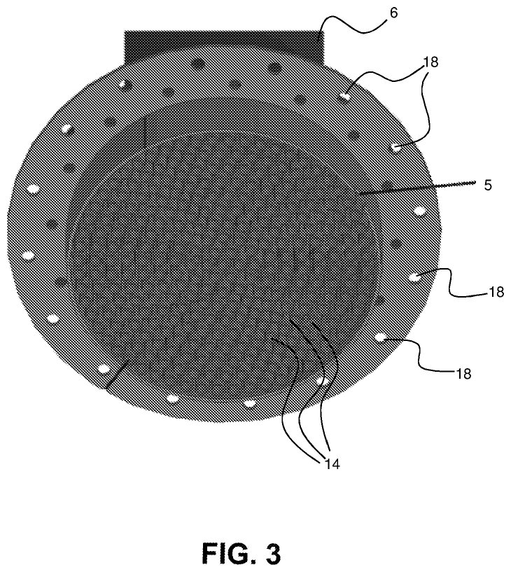

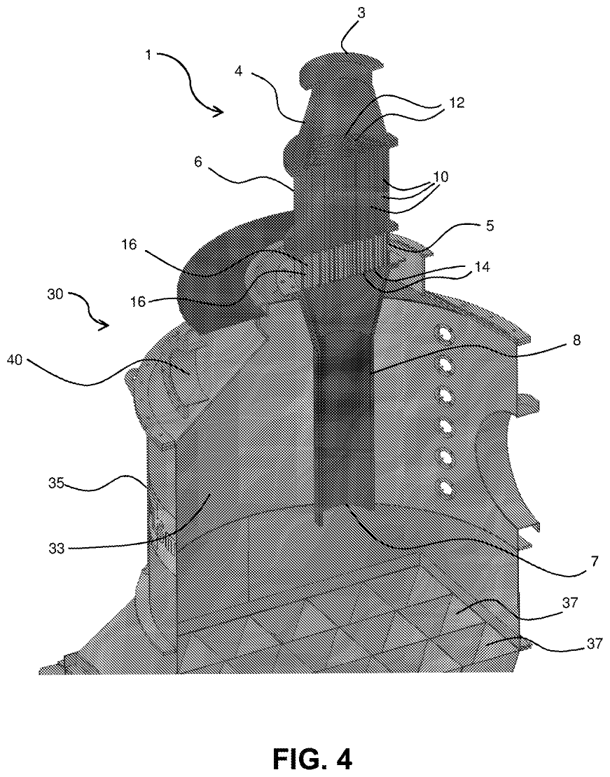

The conduit 2 also comprises a plurality of hollow tubes 10, shown in FIG. 2, with open entry ends 12 for receiving the feed slurry from the slurry inlet 3 and open exit ends 14 for discharging the slurry and gas from the conduit. The hollow tubes 10 also comprise a porous section 16 to enable gas from the gas feed inlet 5 to enter the hollow tubes and generate bubbles of substantially uniform size that flow with the incoming feed slurry from the entry ends 12. Mounting holes 18 are provided for mounting the feed apparatus 1 onto a device 30 for separating low density particles from the feed slurry (as best shown in FIGS. 3 and 4), such as a reflux or inverted reflux classifier.

The upper portion 4 of the conduit has a frusto-conical shape to facilitate distribution of the feed slurry into the entry ends 12 of the hollow tubes 10. Similarly, the lower portion 8 of the conduit has a frusto-conical section 31 to direct and concentrate the gas and slurry into a cylindrical section 32 before discharging through the outlet 7. The cylindrical section 32 effectively acts like a downcomer to deliver the bubbly flow to a chamber of the separating device 30.

The feed slurry is introduced via the slurry feed inlet 3 and passes through the entry end 12 of each hollow tube 10 and flows downwardly along the length of the hollow tubes in the vertical channels formed by the hollow tube walls. Gas (typically in the form of air) is introduced via the gas inlet 5 and passes through the porous section 16 of each hollow tube 10, generating bubbles of substantially uniform size that flow with the feed slurry and adhere to low density hydrophobic particles in the feed slurry. Generally, the gas is fed through the gas inlet 5 in a controlled manner so that fine bubbles preferably in the order of 0.3 mm diameter will emerge from the porous sections 16 of each hollow tube 10 and interact with the hydrophobic particles (which tend to be the low density particles) in the feed slurry passes through the length of the hollow tubes. Hydrophobic particles attached to the air bubbles are entrained downwards through the vertical channels and then discharge from the exit ends 14 of the hollow tubes 10.

The porous section 16 ensures formation of relatively uniformly sized bubbles that flow as part of the slurry suspension and collide with the solid particles, producing adhesion between the hydrophobic particles and the air bubbles to achieve separation. The uniformity in the geometry of the porous section 16 ensures that the strong and consistent shear rate in the flowing slurry suspension causes the air flow through the pores of the porous section 16 to break off and form bubbles of substantially uniform size. Generally, the average pore diameter of the pores or perforations in the porous section may range from 1 mm down to 0.2 microns, depending on the grade of material chosen for the application. In some embodiments, the pores or perforations have an average pore diameter of less than 0.1 mm. In other embodiments, the average pore diameter is 10 microns. In another embodiment, the average pore diameter is 2 microns. In a further embodiment, the average pore diameter is 100 microns.

The feed slurry from the slurry inlet 3 and air via the gas inlet 5 into the hollow tubes 10 leave together through the exit ends 14 into the conduit 2 for discharge from the discharge outlet 7 as a bubbly flow. As best shown in FIG. 4, this bubbly flow enters the chamber 33 of the separating device 30 at an upper end 35 and above a plurality of inclined channels 37, preferably formed by a set of inclined surfaces or ideally by an array of parallel inclined plates. The bubbly flow separates into gas/bubble and slurry components and the rising gas bubbles with attached low density hydrophobic particles rise upwardly on either side of the feed apparatus 1 until they flow into an outlet 40 for recovery. The denser matter and particles descend through the inclined channels towards a discharge outlet (not shown) for removing the denser matter from the chamber 33.

The separating device 30 thus operates in substantially the same manner as described in the above cited international patent application numbers where the separating device 30 is in the form of a reflux classifier or an inverted reflux classifier. However, it will be appreciated that the feed apparatus 1 may be used with other types of separating devices using froth flotation.

The feed apparatus 1 thus provides an alternative configuration to the feed box described in International Patent Application Number PCT/AU2011/000682. Hence, the feed apparatus 1 also has the primary advantage of producing a precise laminar flow field in each channel of the hollow tubes 10. This laminar flow field has a high sheer rate in the range 10 s⁻¹ to 1000 s⁻¹. This high sheer rate is achieved by laminar flow created by the array of hollow tubes 10, which enables a high flow rate of bubbly flow to be achieved at the outlet 7 from the feed apparatus 1. It is appreciated that in practical operations, the feed slurry flow may range from transitional to turbulent, as required.

The feed apparatus 1 also provides the benefits of:
providing an increased surface area for the gas to enter the tubes 10 via the porous sections 16—this, in effect, maximises the surface area of the permeable interface at the porous sections 16 between the air phase and the flowing slurry suspension over a given vertical height (for the vertically arranged hollow tubes 10), as well as presenting this permeable interface to the flowing suspension with a uniform geometry;
providing a confined area for the gas bubbles and slurry to interact, improving the probability of the gas and low density particles attaching;
allowing for scalability (either up or down) in the total surface area through the addition of more tubes 10 or the subtraction of existing tubes 10;
creating a single gas inlet point or multiple gas inlet points with a controlled volume and pressure of gas to all hollow tubes 10;
providing a high shear and a precise laminar flow field being applied to the gas and slurry, resulting in a high flow rate of the bubbly flow into the separating device; and
ensuring that the slurry has a laminar flow before the gas is added to the slurry suspension.

The conduit 2, comprising a plurality of hollow tubes, also has improved scalability through the inverted arrangement of air being supplied on the outside of the feed apparatus 1 through gas inlet 5. Hence, a single feed apparatus 1 is only required in the separating device 30 to accommodate higher flow rates, and the number of hollow tubes 10 can be readily scaled with the cross-sectional area of the separating device 30 without a loss in performance. In some embodiments, there may be reason to include more than one feed apparatus 1. For instance, in other types of separating devices using froth flotation.

While the embodiment has been described as having hollow tubes 10 of circular cross-section, it will be appreciated that in other embodiments, the tubes may have a rectangular, square, oval or any other polygonal cross-section. Also, the hollow tubes 10 may each have one or more portions that have a greater or lesser cross-sectional area than other portions, rather than being uniform in cross-sectional areas as shown in the illustrated embodiments. For example, a hollow tube 10 may have an enlarged open end (i.e. the open end has a larger cross-sectional area than the rest of the hollow tube). Alternatively, the hollow tube may have a contracted open end (i.e. the open end has a smaller cross-sectional area than the rest of the hollow tube). A change in the exit diameter (i.e. the open end) in the feed apparatus 1 can alter the hydrodynamics underpinning the kinetic rate of flotation within the separating apparatus by improving the local combining of the gas into the feed slurry under a variation in the rate of shear. Similarly, a change in the entrance diameter in the feed apparatus 1 may also improve the local combining of the gas with the feed slurry for the same reason.

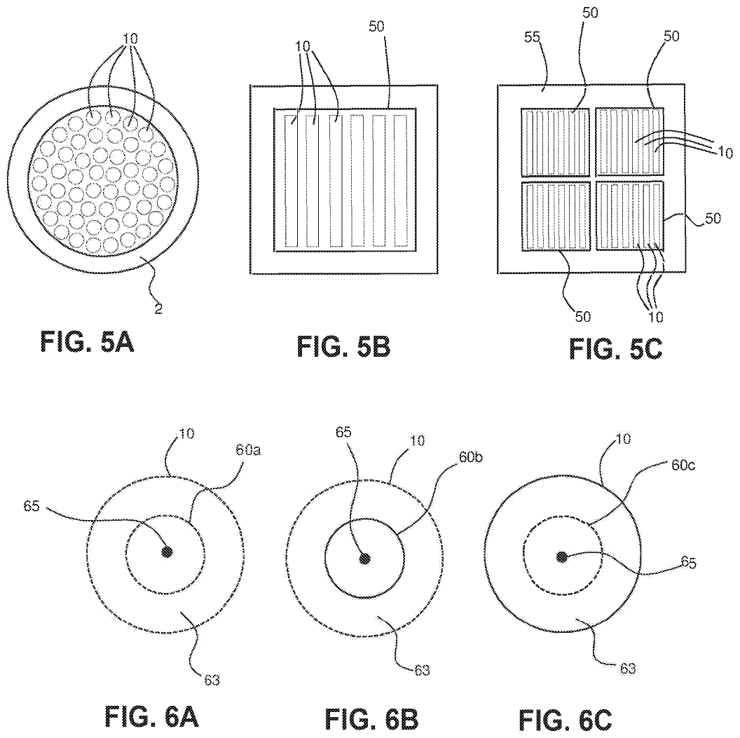

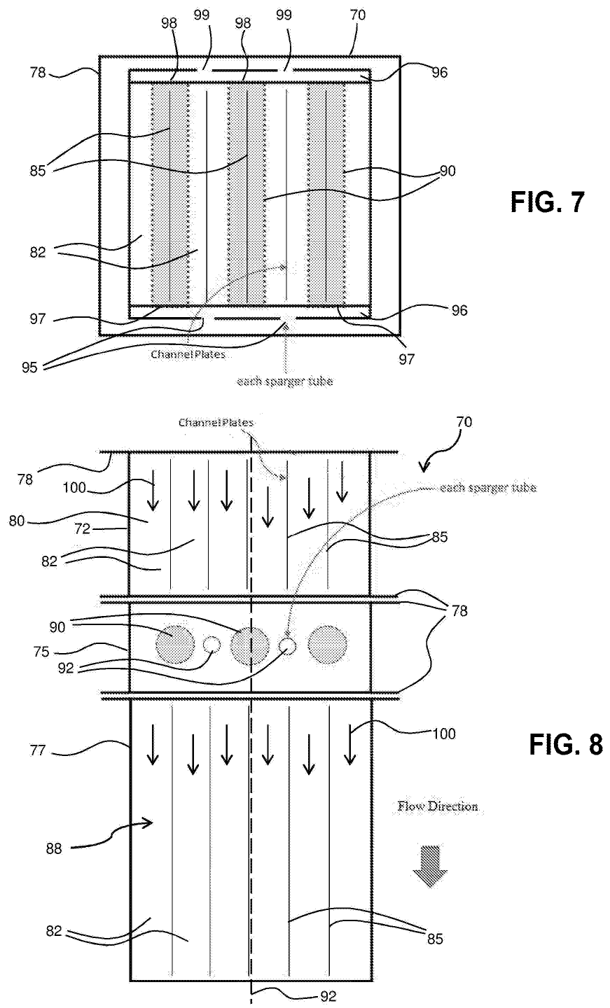

Similarly, the conduit in the form of downcomer 2 has a circular cross-section, but in other embodiments, the conduit may have a rectangular, square, oval or any other polygonal cross-section. FIG. 5 illustrates the top views of different embodiments employing combinations of hollow tubes 10 and conduits 2. In FIG. 5(i), the conduit 2 and hollow tubes 10 both have circular cross-sections. In FIG. 5(ii), the conduit 50 has a rectangular or square cross-section while the hollow tubes 10 are arranged substantially perpendicular to the longitudinal axis of the conduit. In most cases, the hollow tubes 10 will lie generally in the horizontal direction relative to the vertical orientation of the conduit 50. In FIG. 5(iii), there is a plurality of conduits 50 with substantially perpendicular hollow tubes 10 arranged into a conduit housing or array 55. The rectangular cross-section of the conduit 50, array 55, in combination with parallel channels above and/or below the hollow tubes 10 (as described in more detail below in relation to FIGS. 7 to 10) has the advantages of providing a well-defined flow field within the channels, and reducing the risk for particle blockages by providing a second dimension, perpendicular to the direction of flow, for particle movement. Hence, the reduced risk for blockage within a channel provides additional oversized-particle blockage protection, permitting larger sized particles to be processed, and increasing the effective maximum particle diameter by up to a factor of 2 compared to the maximum particle size permitted in hollow tubes 10. However, it will be appreciated that in other embodiments, the conduit 50 and array 55 can be provided without parallel channels. Also, the conduit 2, 50 and array 55 may also have one or more portions that vary in cross-sectional area, as discussed in relation to the hollow tubes 10 above.

In some embodiments, the porous section 16 may comprise a perforated section of the hollow tube 10, a porous surface, an open section covered by a porous material or a membrane.

In some embodiments, the porous section 16 may comprise internally located conduits, tubes or pipes 60, as best shown in FIG. 6, to form an annulus 63 (with a corresponding annular cross-section) or other similar geometries. Generally, the internal conduits 60 are co-axial to the hollow tubes 10 but may simply lie parallel to the longitudinal axis 65 of the hollow tube 10. FIG. 6 shows end views of combinations of hollow tubes 10 with internal conduits 60. FIG. 6(i) illustrates a porous hollow tube 10 and a porous internal tube 60a; FIG. 6(ii) illustrates a porous hollow tube 10 and non-porous internal tube 60b; and FIG. 6 (iii) illustrates a non-porous hollow tube 10 and porous internal tube 60c. In each illustrated configuration, the annulus 63 that is formed permits the gas and feed slurry to combine and flow through the hollow tube 10. The benefits of the annulus 63 include providing a second dimension perpendicular to the direction of flow and a further factor of 2 in particle size, therefore reducing the likelihood of particle blockages. The annulus 63 provides a significant increased shear rate by changing the hydraulic diameter at the cost of a small loss of flow area. For example, a 10% loss in flow area through the porous section 16 will provide a factor of 2 increase in shear rate. In addition, in other embodiments, the inner tube 60 may comprise a perforated section of the inner tube, a porous surface, an open section covered by a porous material or a membrane.

Referring to FIGS. 7 and 8, a further embodiment of the invention is shown. In this embodiment, the conduit in the form of a downcomer 70 comprises an upper section 72, a gas delivery section 75 and a lower section 77 that is longer than the upper section 72. Each section has flanges 78 for mounting to each other and a feed slurry inlet assembly (not shown). A first array 80 of generally parallel channels 82 defined by parallel plates 85 is located in the upper section 72 above the gas delivery section 75. A second array 88 of generally parallel channels 82 defined by parallel plates 85 is located in the lower section below the gas delivery section 75.

The gas delivery section 75 comprises a plurality of hollow tubes in the form of tubular spargers 90 arranged substantially perpendicular to a longitudinal axis 92 of the downcomer 70. Preferably, there is one sparger 90 for every one or two parallel channels 82. A plurality of gas inlets 95 are arranged to deliver a gas in the form of air along an air chamber 96 into one end 97 of the spargers 90. The air flows out the other end 98 into another air chamber 96 and exits via gas outlets 99. The air may be fed to the spargers 90 via a common manifold (not shown) connected to either ends 97, 98 of the spargers.

In the operation of this embodiment, the feed slurry enters through the upper section 72 of the downcomer 70 to flow downwardly through the channels 82, as indicated by arrows 100, and around the spargers 90. Air is delivered to the spargers 90 by the gas inlets 95 and air chamber 96. As the air travels along the length of the spargers 90, a portion of the air discharges through the sidewalls of the spargers to form air bubbles that flow with the downward flow of feed slurry and commence adhesion to the hydrophobic low density particles in the suspension. The substantially perpendicular arrangement of the spargers 90 means that the feed slurry is able to flow over the outer surfaces of the spargers (instead of through the hollow tubes 10 as in the previous embodiments) at high shear rates to achieve effective bubble-particle collisions. Generally, there is a high shear zone and shear gradients around the sparger radius.

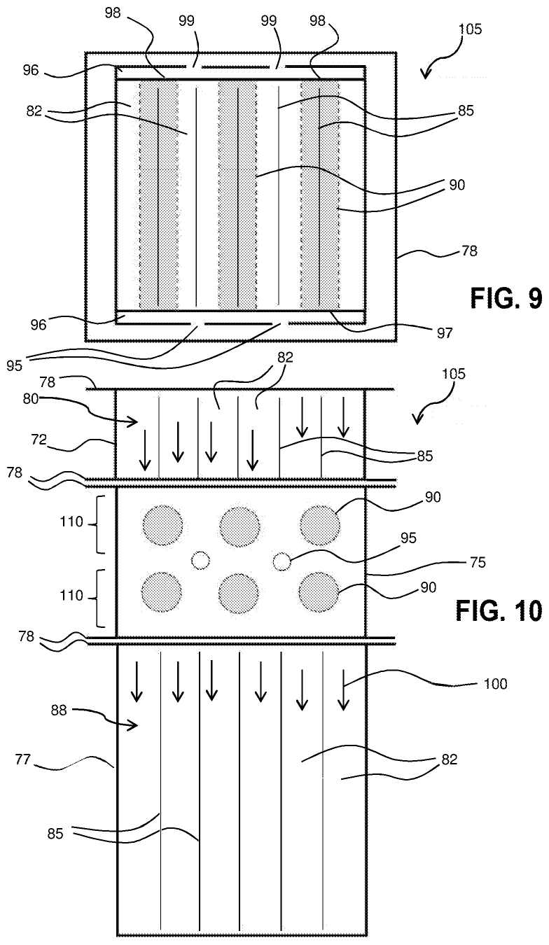

Referring to FIGS. 9 and 10, a further embodiment of the invention is illustrated. In this embodiment, the conduit 105 is substantially the same as the conduit 70 of FIGS. 7 and 8. However, the gas delivery section 75 comprises tubular spargers 90 arranged in multiple rows 110 that are vertically aligned. In some embodiments, the spargers 90 may be arranged in stacks.

It is contemplated that the use of parallel channels 82 provides better scale up options over the use of hollow tubes 10 in the previous embodiments and may lower the pressure drop and/or energy requirements for the apparatus. A further advantage of using parallel channels 82 is that they provide a well-defined flow field within the channels and reduce the risk for particle blockage within the channel by providing a second dimension, perpendicular to the direction of flow, for particle movement. This provides additional oversized-particle blockage protection, permitting larger sized particles to be processed, and increasing the effective maximum particle diameter by up to a factor of 2 compared to the maximum particle size permitted in hollow tubes 10.

In some embodiments, the parallel plates 85 do not extend along the full length of the lower section 77. However, it is preferred that the parallel plates 85 extend along the full length of the lower section 77 to improve bubble-particle collisions.

In some embodiments, the downcomers 70, 105 may be sheathed in a circular tube. While the embodiments shown in FIGS. 7 to 10 have downcomers 70, 105 with square cross sections (i.e. the downcomers are symmetrical), it will be appreciated that the downcomers 70, 105 in other embodiments may have rectangular, circular, oval, hexagonal or any other polygonal cross-section.

The embodiment of FIGS. 7 to 10 has the same technical advantages of the embodiment of FIGS. 1 to 4, as discussed above. Moreover, the connectivity between all the elements of the slurry suspension flow can be maintained by subdividing the air flow through the hollow tubes and associated porous sections (as exemplified by FIGS. 1 to 4), or the connectivity between all the elements of our air/gas flow can be maintained by subdividing the slurry suspension flow through the hollow tubes and associate porous sections (as exemplified by FIGS. 7 to 10). In addition, a large permeable surface area between the gas and slurry phases is achieved with porous sections 16 in a manner that achieves geometrical uniformity. The geometrical length scale is best measured via the so-called hydraulic diameter defined as 4× flow area of the suspension in total divided by the wetted perimeter, the wetted perimeter being the perimeter of the porous surface/section 16. This hydraulic diameter and suspension flow velocity then governs the shear rate. Thus, in effect, the subdivision of either the air/gas flow or the slurry suspension flow results in creating a larger interface area between the gas and liquid phases, through which the gas phase enters the liquid phase for the purpose of forming bubbles at the interface (the porous section 16), via shear from the flowing feed slurry suspension. The substantially uniform bubble size of the relatively fine air bubbles is effective in recovering hydrophobic (low density) particles of a relatively fine size by flotation. Also, the uniform geometry of the porous section assists in producing a distinct shear rate to promote bubble-particle collisions and attachment.

In other embodiments, the discharge outlet 7 of the feed apparatus 1 need not extend into the upper end 35 of the chamber 33 but may instead be located at the top of the chamber 33 or extend further towards or at a mid-point or middle portion of the chamber 33. Ideally, the discharge outlet 7 is located above the plurality of the inclined channels 37. Hence, there could be a configuration where the discharge outlet 7 is located toward or at a lower end of the chamber 33. In addition, the plurality of inclined channels 37 may be located anywhere in the chamber 33, where desired, including the upper end 35, the middle portion or lower end of the chamber 33.

In some embodiments, the hollow tubes 10 may be inclined, if desired, within the conduit 2 instead of being arranged to extend vertically. In addition, the hollow tubes 10 may simply extend axially within the conduit substantially parallel to the conduit walls (and hence the feed apparatus 1 may have an inclined conduit 2 with inclined hollow tubes 10).

In other embodiments, the hollow tubes 10 extend further along the length of the conduit 2 past the middle portion 6 and into the lower portion 8 to discharge the feed slurry and gas from their respective exit ends 14 closer to the conduit outlet 7. In another embodiment, the exit end 14 of each hollow tube 10 is adjacent to the conduit outlet 7.

In some embodiments, the shape of the conduit 2 may vary as desired. Hence, the upper portion 4 and the section 31 of the lower portion 8 need not be frusto-conical in shape.

It is also contemplated that the feed apparatus 1 is particularly suitable for high volumetric feed rates and low solids concentrations or low feed grades, and may be used with wash water being added to the bubbly flow in the chamber 33 of the separating device 30 from above. In this regard, it should be noted that the separating device 30 illustrated in FIG. 4 does not use wash water.

The objective of this embodiment is to recover all of the hydrophobic particles and, in this case, some entrained hydrophilic particles in the final product can be anticipated. In this arrangement it is not essential for foam to form. There are benefits in not having to maintain or control foam because foams can be highly variable in their stability.

It is further noted that the vast majority of the volumetric flow would normally tend to discharge out the bottom of the vessel. Hence the system would operate effectively under dilute conditions, and hence there would be good distribution of this flow down all of the inclined channels. Higher system concentrations could still be used.

It is further noted that the device would operate effectively at feed and gas rates higher than used in a conventional froth flotation device and would operate with higher wash water rates. These higher rates are made possible by the powerful effect of the inclined channels in the lower part of the system. These channels provide for an increase in the effective vessel area allowing gas bubbles that might otherwise be entrained downwards to the underflow to rise upwards towards the overflow.

It will further be appreciated that any of the features in the preferred embodiments of the invention can be combined together and are not necessarily applied in isolation from each other. For example, the feature of inclined hollow tubes 10 and the feature of a rectangular upper portion may be combined into the same feed apparatus 1. Similar combinations of two or more features from the above described embodiments of the invention can be readily made by one skilled in the art.

By providing the feed apparatus with hollow tubes each having a porous section, a useful alternative configuration for feeding the slurry into a separating device is provided that has the same benefits of high shear and a precise laminar flow field being applied, resulting in a high flow rate of the bubbly flow into the separating device. Consequently, the feed slurry is delivered quickly and efficiently, and is conditioned (due to being combined with the gas generated bubbles) for separation of the low density particles. Furthermore, the porous section maximises the surface area of the permeable interface between the air phase and the flowing slurry suspension, increasing the amount of substantially uniform bubble generation. The porous section also ensures that the permeable interface has a uniform geometry. In all these respects, the invention represents a practical and commercially significant improvement over the prior art.

Although the invention has been described with reference to specific examples, it will be appreciated by those skilled in the art that the invention may be embodied in many other forms.

1-24. (canceled)

25. An apparatus for feeding a feed slurry into a device for separating low density particles from the feed slurry, the apparatus comprising:
a conduit having a slurry inlet for receiving the feed slurry, a gas feed inlet for receiving a gas and an outlet for discharging the gas and feed slurry; and
a plurality of hollow tubes within the conduit for combining the feed slurry and gas from the slurry and gas feed inlets;
wherein one or more of the hollow tubes comprise a non-porous section for directing the flow of the feed slurry and gas and a porous section to generate bubbles of substantially uniform size into the feed slurry flowing within the conduit.

26. The apparatus of claim 25, wherein the one or more hollow tubes comprise a porous surface.

27. The apparatus of claim 25, wherein the porous section is formed at a lower portion of the one or more hollow tubes.

28. The apparatus of claim 25, wherein the porous section is formed in the sidewalls of the one or more hollow tubes.

29. The apparatus of claim 25, wherein the porous section comprises pores or perforations having an average diameter of less than 1 mm to 0.1 microns.

30. The apparatus of claim 25, wherein the porous section has a porosity of between 1% to 90%, preferably 10% and 80%.

31. The apparatus of claim 25, wherein the porous section is in fluid communication with the gas feed inlet to receive gas from the gas feed inlet and generate the bubbles of substantially uniform size into the slurry flowing in the one or more hollow tubes.

32. An apparatus for feeding a feed slurry into a device for separating low density particles from the feed slurry, the apparatus comprising:
a conduit having a slurry inlet for receiving the feed slurry, a gas feed inlet for receiving a gas and an outlet for discharging the gas and feed slurry;
a plurality of hollow tubes within the conduit for combining the feed slurry and gas from the slurry and gas feed inlets, wherein the hollow tubes are positioned substantially perpendicular to a longitudinal axis of the conduit and arranged in one or more rows; and
a plurality of channels located above and below the hollow tubes, the channels being positioned axially within the conduit;
wherein the hollow tubes each comprise a porous section to generate bubbles of substantially uniform size into the feed slurry flowing within the conduit.

33. The apparatus of claim 32, wherein the one or more hollow tubes each have an open end in fluid communication with the gas feed inlet, the open end receiving the gas from the gas feed inlet so that the porous section of each of the one or more hollow tubes receives the gas from the one or more hollow tubes and generates the bubbles of substantially uniform size into the feed slurry flowing within the conduit.

34. The apparatus of claim 32, wherein the channels are defined by a plurality of parallel plates.

35. The apparatus of claim 32, wherein the hollow tubes comprise a porous surface.

36. The apparatus of claim 32, wherein the porous section is formed in the sidewalls of the one or more hollow tubes.

37. The apparatus of claim 32, wherein the porous section comprises pores or perforations having an average diameter of less than 1 mm to 0.1 microns.

38. The apparatus of claim 32, wherein the porous section has a porosity of between 1% to 90%, preferably 10% and 80%.

39. The apparatus of claim 25, wherein the one or more hollow tubes each comprise an inner conduit, tube or pipe to define an annulus between the hollow tube and the inner conduit, tube or pipe.

40. The apparatus of claim 39, wherein the inner conduit, tube or pipe comprises a porous section for generating the bubbles of substantially uniform size into the feed slurry.

41. The apparatus claim 25, wherein the one or more hollow tubes comprise at least one of (a) an expanded portion having a cross-sectional area greater than the cross-sectional area of the remainder of the one or more hollow tubes; and (b) a contracted portion having a cross-sectional area less than the cross-sectional area of the remainder of the one or more hollow tubes.

42. An apparatus for separating low density particles from a feed slurry, comprising:
a chamber having a plurality of inclined channels;
a slurry feeder arranged to feed the feed slurry into the feed apparatus of claim 25; and
a gas feeder arranged to feed gas into the feed apparatus;
wherein the outlet of the feed apparatus is arranged to feed the gas and slurry into the chamber.

43. A method of feeding gas and a feed slurry into a device for separation low density particles from the feed slurry, comprising:
introducing the feed slurry into a slurry inlet of a conduit;
introducing gas into a gas feed inlet of the conduit;
conveying the feed slurry and gas into a plurality of hollow tubes so that the feed slurry and gas is discharged from an outlet of the conduit into the separation device; and
providing one of more of the hollow tubes with a non-porous section for directing the flow of the feed slurry and gas and a porous section or surface to generate bubbles of substantially uniform size into the feed slurry flowing within the conduit.

44. The method of claim 43, comprising forming the porous section or surface at a lower portion of the one or more hollow tubes.

45. The method of claim 43, comprising introducing the gas from the gas feed inlet into the one of more hollow tubes through the porous section or surface to generate bubbles of substantially uniform size into the feed slurry flowing the slurry flowing along the one of more hollow tubes.

46. A method of feeding gas and a feed slurry into a device for separation low density particles from the feed slurry, comprising:
introducing the feed slurry into a slurry inlet of a conduit;
introducing gas into a gas feed inlet of the conduit;
positioning a plurality of hollow tubes substantially perpendicular to a longitudinal axis of the conduit and arranged in one or more rows;
positioning a plurality of channels located above and below the hollow tubes, the channels being positioned axially within the conduit;
conveying the feed slurry and gas into a plurality of hollow tubes so that the feed slurry and gas is discharged from an outlet of the conduit into the separation device; and
providing the hollow tubes with a porous section or surface to generate bubbles of substantially uniform size into the feed slurry flowing within the conduit.

47. The method of claim 46, comprising introducing the gas from the gas feed inlet into the hollow tubes and discharging the gas through the porous section or surface in the form of the bubbles of substantially uniform size into the feed slurry flowing within the conduit.

48. A method of separating low density particles from a feed slurry containing such particles, comprising:
introducing the feed slurry and a gas into a device for separating the low density particles from the feed slurry according to the method of claim 43, wherein the separating device comprises a chamber having plurality of inclined channels;
allowing the slurry to flow downwardly through the inclined channels such that the low density particles escape the flow by sliding up the inclined channels while the denser particles in the slurry slide down the channels; and
removing the low density particles from the chamber.

49. A method of separating low density particles from a feed slurry containing such particles, comprising:
introducing the feed slurry and a gas into a device for separating the low density particles from the feed slurry according to the method of claim 46, wherein the separating device comprises a chamber having plurality of inclined channels;
allowing the slurry to flow downwardly through the inclined channels such that the low density particles escape the flow by sliding up the inclined channels while the denser particles in the slurry slide down the channels; and
removing the low density particles from the chamber.
